(19) United States
(12) Patent Application Publication
(10) Pub. No.: US 2009/0157830 A1
(43) Pub. Date: Jun. 18, 2009

(54) APPARATUS FOR AND METHOD OF GENERATING A MULTIMEDIA EMAIL

(75) Inventor: Se-hyun KIM, Daejeon Metropolitian City (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/189,840

(22) Filed: Aug. 12, 2008

(30) Foreign Application Priority Data
Dec. 13, 2007 (KR) 2007-129905

(51) Int. Cl. G06F 15/16

(52) U.S. Cl. 709/206

(57) ABSTRACT

An apparatus for and method of synthesizing multimedia email including an audio file and a video file, and a computer readable recording medium having embodied thereon a computer program to execute the method. The apparatus for synthesizing multimedia email includes an email analysis unit to analyze the content of an email, an audio file synthesis unit to synthesize an audio file by using the analysis result by the email analysis unit, a video file synthesis unit synthesizing a video file by using the analysis result by the email analysis unit, and an audio/video file combining module to combine the audio file and video file. The multimedia email synthesized by the method and apparatus can provide more user-friendly and more various types of information than conventional technology, and increases utilization of an apparatus.

### CROSS-REFERENCE TO RELATED APPLICATIONS

This application claims priority under 35 U.S.C. §119(a) from Korean Patent Application No. 10-2007-0129905, filed on Dec. 13, 2007, in the Korean Intellectual Property Office, the disclosure of which is incorporated herein in its entirety by reference.

### BACKGROUND OF THE INVENTION

1. Field of the Invention

The present general inventive concept relates to email, and more particularly, to an apparatus for and method of synthesizing a multimedia email from an ordinary email.

2. Description of the Related Art

In general, if an email is received, a user (or a receiver) executes an email program, thereby reading the email displayed on the screen and learning the content.

However, this visual email transfer method is limited in that the email can be confirmed by using only the eyes of the user.

Also, items provided by the conventional email program are limited; that is, information provided by only an email sender or a mail server is provided to the receiver.

Recently, in addition to this traditional email reading method, a method of providing an email by voice has been under development. That is, according to the method, an email in the form of text is converted into voice by using a text-to-speech (TTS) engine, and the content of the email is transferred acoustically to a user.

However, since the method of confirming an email only by voice relies on only the acoustic sense of the user, the amount of information that can be transferred to the user is limited. Also, apparatuses used for confirmation of an email, i.e., a personal computer (PC), a personal digital assistant (PDA), and a mobile phone, generally include both a display and a speaker. When this fact is considered, the conventional method of confirming an email relying only on the visual sense or acoustic sense does not sufficiently utilize resources of a given apparatus.

Also, since the conventional method of providing a voice email provides only standardized voice or background sound, the preference of a user or the content of an individual email cannot be reflected.

### SUMMARY OF THE INVENTION

The present general inventive concept provides an apparatus for and method of synthesizing a multimedia email combining an audio file and/or a video file so that more information related to an email can be provided and the preference of a user or the content of an email can be reflected.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieve by providing an apparatus to synthesize a multimedia email, the apparatus including an email analysis unit to analyze the content of an email, an audio file synthesis unit to synthesize an audio file by using the analysis result by the email analysis unit, a video file synthesis unit to synthesize a video file by using the analysis result by the email analysis unit, and an audio/video file combining module to combine the audio file and video file.

The foregoing and/or other aspects and utilities of the present general inventive concept may also be achieved by providing a method of synthesizing a multimedia email, the method including analyzing the content of an email, synthesizing an audio file by using at least part of the analysis result of the content of the email, synthesizing a video file by using at least part of the analysis result of the content of the email, and combining the synthesized audio file and video file.

The foregoing and/or other aspects and utilities of the present general inventive concept may also be achieved by providing a computer readable medium having embodied thereon a computer program to execute a method of synthesizing a multimedia email, wherein the method includes analyzing the content of an email, synthesizing an audio file by using at least part of the analysis result of the content of the email, synthesizing a video file by using at least part of the analysis result of the content of the email, and combining the synthesized audio file and video file.

The foregoing and/or other aspects and utilities of the general inventive concept may also be achieved by providing a method of presenting a multimedia email, the method including analyzing the content of an email, receiving a selection of an email presentation mode, and based at least in part on the received selection and the analysis result of the content of the email, synthesizing a multimedia file using an audio file, a video file, or an audio file and a video file.

The foregoing and/or other aspects and utilities of the general inventive concept may also be achieved by providing a computer readable medium having embodied thereon a computer program to execute a method of presenting a multimedia email, wherein the method includes analyzing the content of an email, receiving a selection of an email presentation mode, and based at least in part on the received selection and the analysis result of the content of the email, synthesizing a multimedia file using an audio file, a video file, or an audio file and a video file.

The foregoing and/or other aspects and utilities of the present general inventive concept may also be achieved by providing an apparatus to synthesize a multimedia email, the apparatus including an email analysis unit to analyze an email to generate a signal included in the email, and a synthesis unit to synthesize at least one of an audio file and a video file according to the generated signal.

The synthesis unit of the apparatus may also include a text-to-speech converter to convert a text of the email to a speech signal, and the synthesis unit to synthesize the at least one of the audio file and the video file with the speech signal.

The apparatus to synthesize a multimedia email may also include a storage unit to store the audio file and the video file.

The apparatus to synthesize a multimedia email may also include that the signal has a tag of the email and a keyword of the email.

The apparatus and method of the general inventive concept may further include a variety of background sounds related to the content of an email that can be inserted in addition to voice data, thereby helping a user listen and understand the content of the email and furthermore enjoy the email.

The present general inventive concept may further include that while listening to an email converted into voice, if additional information is needed, the body of the email which is being listened to and information on the email sender can be provided through a display apparatus. Also, through analysis of an email, background images related to the content of the email may be inserted, thereby helping the user understand the content of the email and providing an emotional amusement to the user.

That is, a multimedia email according to the present general inventive concept can provide more user-friendly and more various types of information than conventional technology, and increases utilization of an apparatus.

### BRIEF DESCRIPTION OF THE DRAWINGS

The above and other features and advantages of the present general inventive concept will become more apparent by describing in detail exemplary embodiments thereof with reference to the attached drawings in which:

FIG. 1 is a functional block diagram illustrating a structure of a multimedia email synthesis apparatus according to an embodiment of the present general inventive concept;

FIG. 2A is a functional block diagram illustrating a detailed structure of an email pre-processing module illustrated in FIG. 1 according to an embodiment of the present general inventive concept;

FIG. 2B is a diagram illustrating the types of data stored in a file synthesis data DB illustrated in FIG. 1 according to an embodiment of the present general inventive concept;

FIG. 3 is a functional block diagram illustrating a structure of an apparatus for reproducing a synthesized multimedia email according to an embodiment of the present general inventive concept;

FIG. 4 is a flowchart illustrating operations of a method of synthesizing a multimedia email according to an embodiment of the present general inventive concept;

FIG. 5 is a flowchart illustrating more detailed operations of an email pre-processing operation illustrated in FIG. 4 according to an embodiment of the present general inventive concept;

FIG. 6 is a flowchart illustrating in more detail an operation for synthesizing an audio file illustrated in FIG. 4 according to an embodiment of the present general inventive concept; and

FIG. 7 is a flowchart illustrating in more detail an operation for synthesizing a video file illustrated in FIG. 4 according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

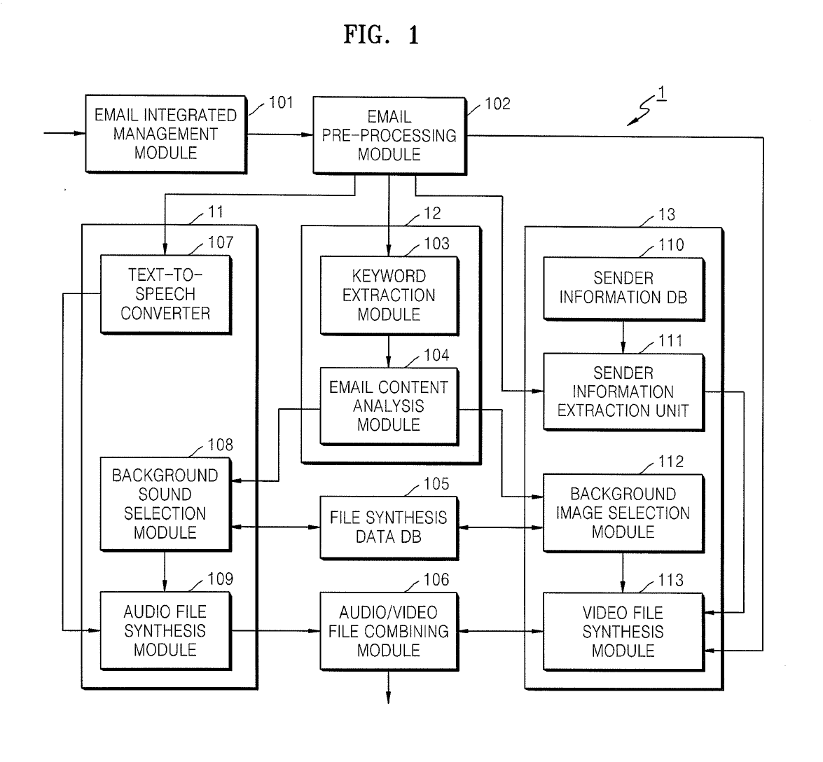

FIG. 1 is a functional block diagram illustrating a structure of a multimedia email synthesis apparatus 1 according to an embodiment of the present general inventive concept. The multimedia synthesis apparatus 1 may be a personal computer, a server computer, a host computer, a mobile phone, a personal digital assistant, an email receiver, or any other apparatus having one or more email functions.

The multimedia email synthesis apparatus 1 according to the current embodiment broadly includes an email integrated management module 101, an email pre-processing module 102, an email analysis block 12, an audio file synthesis block 11, a video file synthesis block 13, a file synthesis data database (DB) 105, and an audio/video file combining module 106.

The email integrated management module 101 downloads one or more emails in an account of a user (or an email receiver) from an external web mail server connected through a network interface or from an internal mail server, and collects the emails.

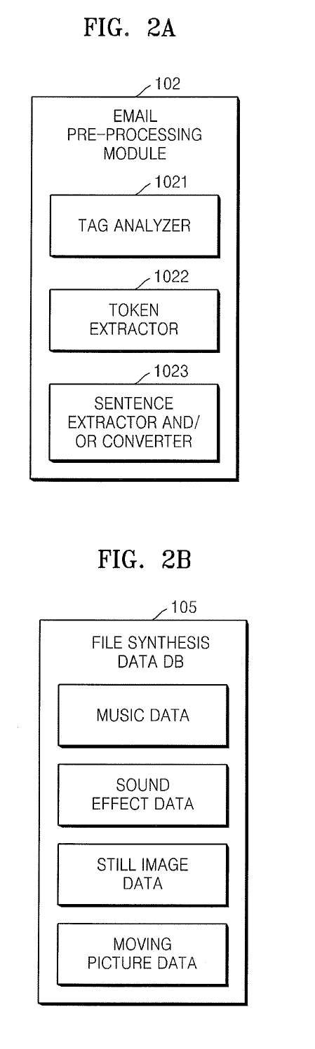

The email pre-processing module 102 analyzes, extracts, and converts emails collected by the email integrated management module 102, and includes a tag analyzer 1021, a token extractor 1022, and a sentence extractor and/or converter 1023 as illustrated in FIG. 2A. Additionally, the email pre-processing module 102 may execute any other suitable pre-processing operations on the one or more collected emails.

The tag analyzer 1021 classifies items forming one email by referring to a tag of each item. Examples of representative tags forming an email include a sender, a receiver, a title, a date, a signature, an original message, retransmission content, a main body, and the like.

The email token extractor 1022 extracts the content of an item corresponding to each tag, i.e., a token, by referring to the classification result by the tag analyzer 1021. For example, the email pre-processing module 102 may extract the email address of a sender linked to a “sender” tag, or the body data linked to a “body” tag. Here, the sender and the body correspond to tags, and the email address of the sender and the body data correspond to tokens.

From the tokens extracted by the email token extractor 1022, the sentence extractor and/or converter 1023 is configured to extract and/or convert the tokens into a sentence to be used for generation of an audio file and/or a video file.

For example, in order to generate a document for displaying the body to be transmitted to a video file synthesis module 113 of the video synthesis block 13, the sentence extractor and/or converter 1023 selects a body token from among the tokens extracted by the token extractor 1022, and excludes the remaining tokens. In this case, the body contains content which the sender desires to transmit to a receiver, and is distinguished from an email address, a signature, an original message, etc. Also, in order to generate a voice synthesis document to be used by a text-to-speech converter 107 (of audio file synthesis block 11), the body token is extracted and one or more abbreviations and user-specified symbols included in the body are converted into pronunciation symbols. A document for displaying a body may have the same content as a document for voice synthesis. Also, the sentence extractor and/or converter 1023 may extract a sender ID required for extracting sender information, and transmits the sender ID to the sender information extraction unit 111.

The email analysis block 12 illustrated in FIG. 1 includes a keyword extraction module 103 and an email content analysis module 104.

The keyword extraction module 103 extracts one or more keywords from the one or more tokens received from the email pre-processing module 102. The keywords indicate words that can be criteria for classification when an email is divided into categories in the email content analysis module 104, and include words that repeatedly appear in the email and/or are registered as meaningful words through a learning process. For example a word like “Hi”, commonly appearing in many emails, is typically not classified as a keyword. Categories may indicate such topics as weather, family, politics, business, shopping information, economy, etc. For example, if extracted keywords are “the lowest price” or “limited bargain sale”, the email content analysis module 104 may associate the extracted keywords with a shopping information category, and if the keyword is “stock”, module 104 may associate the extracted keyword with a business or economy category. Associating extracted keywords with one or more categories may be based on probability and/or stochastic operations. A probability that each keyword belongs to a predetermined category may be typically determined in advance, for example, in a learning process. That is, extraction of a keyword is a process in which keywords registered in a learning process are extracted.

By using one or more keywords extracted from an email by the keyword extraction module 103, the email content analysis module 104 analyzes the content of the email. For example, a probability that each keyword extracted from the body of the email belongs to a predetermined category is calculated and this probability is accumulated by category. Then, a category having a highest accumulated probability is selected.

In another embodiment of the present general inventive concept, in order to select a category, the email content analysis module 104 may, for example, use sender information and an email title instead of keywords of the body of the email.

The file synthesis data DB 105 illustrated in FIG. 1 includes, for example, a variety of music data for each theme and/or classification, sound effect data, still image data, and moving picture data as illustrated in FIG. 2B.

The audio file synthesis block 11 illustrated in FIG. 1 includes the text-to-speed converter 107, a background sound selection module 108, and an audio file synthesis module 109.

The text-to-speech converter 107 converts text into voice by using the pronunciation symbols and/or other related data included in a voice synthesis document received from the email pre-processing module 102.

The background sound selection module 108 selects an appropriate background sound (for example, music data, or sound effect data, or any combination thereof) stored in the file synthesis data DB 105, by referring to the analysis result received from the email content analysis module 104. For example, if an email is received from a family member, a song, such as “Home Sweet Home”, can be selected as a background sound, and if an email is received from a young daughter from among the family, laughter of the child or a song sung by the child may be recorded and stored as sound effect data (i.e., laughter) or music data (i.e., the song sung by the child), which can be inserted.

The audio file synthesis module 109 adjusts the volume levels of the voice data converted by the text-to-speech converter 108 and the background sound selected by the background sound selection module 108, and combines them so as to generate an audio file. Also, the audio file synthesis module 109 encodes the audio file according to an audio format (e.g., MP3, AAC, OGG, wave, etc.) selected by a user.

The video file synthesis block 13 includes a sender information DB 110, a sender information extraction unit 111, a background image selection module 112, and a video file synthesis module 113.

The sender information DB 110 includes information related to a sender sending an email. Examples of this information include personal information, such as the name of a sender, occupation, importance, workplace, the photo of a sender, and memos written by a user in relation to a sender.

The sender information extraction unit 111 first receives a sender identification (ID) (for example, an email address) from the email pre-processing module 102, and then, extracts sender information corresponding to this ID from the sender information DB 110.

The background image selection module 112 selects an appropriate background image from among images (for example, still image data, moving picture data) stored in the file synthesis DB 105, by referring to the analysis result received from the email content analysis module 104. For example, if an email is received from a customer, a photo recalling the customer or a photo taken with the customer can be selected.

The video file synthesis module 113 combines one or more of the document for displaying the body received from the email pre-processing module 102, the sender information extracted by the sender information extraction unit 111, and the background image selected by the background image selection module 112, thereby generating one video file.

Also, the video file synthesis module 113 encodes the video file according to a video format (for example, MPEG, flash, wmv, etc.) selected by the user.

The audio/video file combining module 106 combines the audio file synthesized by the audio file synthesis block 11 and the video file synthesized by the video file synthesis block 13, thereby generating one multimedia email file.

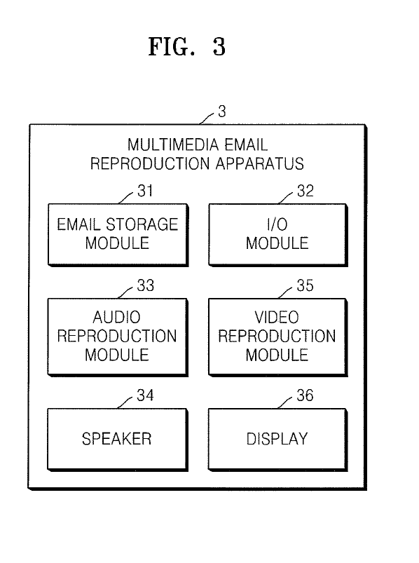

FIG. 3 illustrates an apparatus 3 to reproduce a multimedia email synthesized by the multimedia email synthesis apparatus 1. The apparatus 3 to reproduce a multimedia email includes an email storage module 31, an input/output module 32, an audio reproduction module 33, a speaker 34, a video reproduction module 35, and a display 36.

A multimedia email received from the email synthesis apparatus 1 through the input/output module 32 is first stored in the email storage module 31.

If the stored multimedia email is reproduced by using the reproduction apparatus 3, an audio file in the email file is decoded by an audio reproduction module 33, and then, is transmitted to a user as an audio signal (voice and background sound) through speakers, earphones or headphones.

Also, a video file in the email file is decoded by the video reproduction module 35 and is displayed on the display 36 as a visual signal. A visual signal may include, for example a body, sender information, or a background image, or any other suitable information, or any combination thereof. When the video file includes a plurality of images, one or more of the images can displayed when the email is displayed.

In an embodiment of the present general inventive concept, the email synthesis apparatus 1 and the multimedia email reproduction apparatus 3 may be combined and implemented as one apparatus. In another embodiment of the present general inventive concept, the email synthesis apparatus 1 and the multimedia email reproduction apparatus 3 may be implemented as independent and physically separated apparatuses.

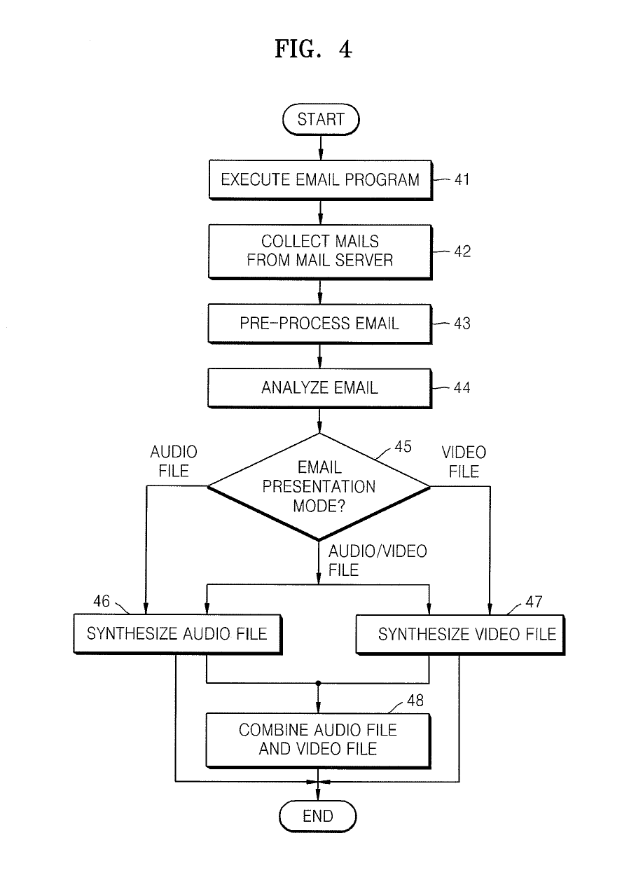

FIG. 4 is a flowchart illustrating a method of synthesizing a multimedia email according to an embodiment of the present general inventive concept.

A user executes an email program (e.g., email management program or other suitable program) or an email viewer according to the present general inventive concept in order to read an email in operation 41.

Once the email program is executed, or at any other suitable time period, an email integrated management module downloads an email of a user account from a web mail server or an internal mail server and collects emails in operation 42.

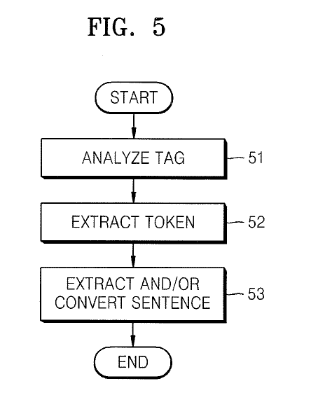

In operation 43, an email pre-processing module performs a process for analyzing, extracting, and converting emails collected in operation 42 in order to synthesize an audio file and/or a video file. The details performed in operation 43 will be explained later with reference to FIG. 5.

In operation 44, the content of an email is analyzed.

A keyword extraction module 103 (illustrated in FIG. 1) extracts one or more keywords determined for one or more categories from tokens received from an email pre-processing module (e.g., email pre-processing module 102 illustrated in FIG. 1). An email content analysis module 104 analyzes the content of an email by using the keywords extracted by, for example, the keyword extraction module 103, or sender information, email title, and the like, and selects a category corresponding to the email.

In operation 45, the user selects an email presentation mode. The email presentation mode that can be selected by the user includes an audio email mode, a video email mode, and an audio/video email mode.

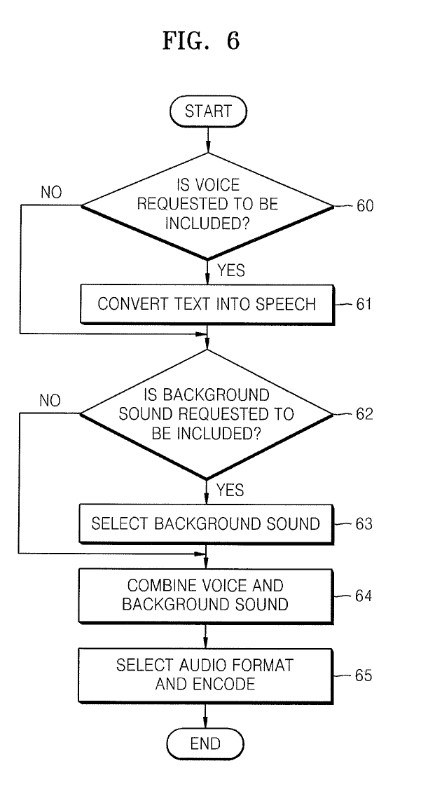

If the user selects an audio email mode as an email presentation mode in operation 45, an audio file synthesis process is performed in operation 46. The audio file synthesis operation includes text-to-speech conversion and/or background sound selection. Details of the operation will be explained later with reference to FIG. 6.

If the user selects a video email mode as an email presentation mode in operation 45, a video file synthesis process is performed in operation 47.

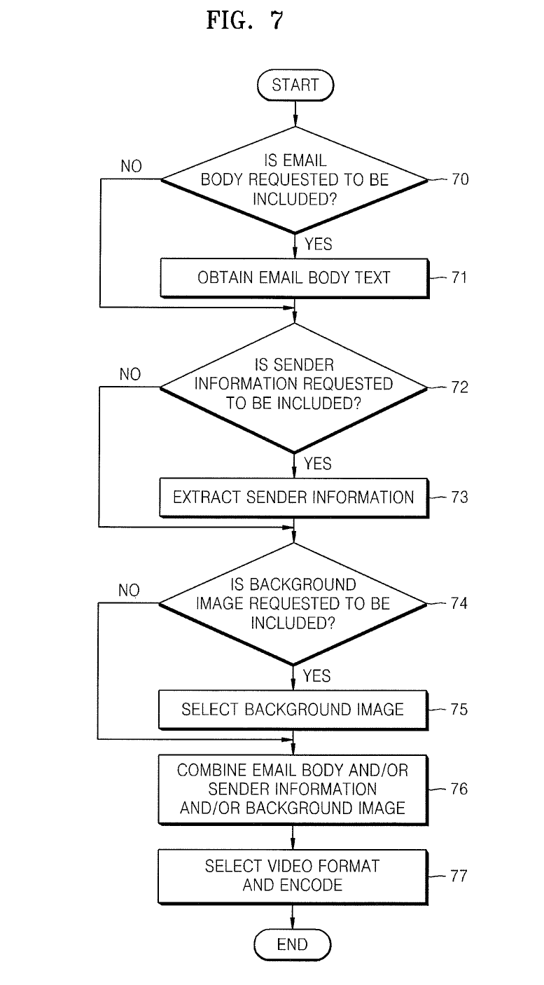

The video file synthesis operation includes processes for acquiring and combining an email body, sender information and a background image. Details of the operation will be explained later with reference to FIG. 7.

If the user selects an audio/video email mode as an email presentation mode in operation 45, both the audio file synthesis (operation 46) and the video file synthesis (operation 47) are performed.

In operation 48, an audio file and a video file are combined (e.g., if the audio/video email mode is selected as an email presentation mode in operation 45). If an audio/video email mode is selected (e.g., in operation 45), the audio file synthesized in operation 46 and the video file synthesized in operation 47 are combined, thereby generating one multimedia email file. In this case, voice data included in the audio file and body data included in the video data may be synchronized with each other.

FIG. 5 is a flowchart illustrating operations of the email pre-processing operation 43 illustrated in FIG. 4 according to an embodiment of the present general inventive concept. Operation 43 is performed by an email pre-processing module 102 of FIG. 1.

In operation 51, a tag analyzer 1021 classifies items forming an email, by referring to tags.

In operation 52, an email token extractor 1022 extracts the content of each item corresponding to each tag, i.e., a token, by referring to the classification result by the tag analyzer (e.g., tag analyzer 1021 illustrated in FIG. 2A).

In operation 53, a sentence extractor and/or converter 1023 extracts and/or converts data to be used for generation of an audio file and/or a video file from the tokens extracted in operation 52.

FIG. 6 is a flowchart illustrating an operation for synthesizing an audio file illustrated in FIG. 4 according to an embodiment of the present general inventive concept.

It is determined whether or not a user requests voice to be included in an audio file in operation 60. If there is a request for voice to be included, text is converted into speech in operation 61. A text-to-speech converter 107 (illustrated in FIG. 1) receives an input of a document for voice synthesis generated in operation 53 for extracting and/or converting a sentence, and converts text into corresponding voice by using the pronunciation symbols included in the document or any other suitable data.

In operation 62, it is determined whether or not the user requests a background sound to be inserted into an audio file (or a multimedia email).

If the user requests the background sound to be inserted, a background sound to be inserted is selected in operation 63. A background sound selection module 108 (illustrated in FIG. 1) selects a background sound (for example, music data, sound effect data) stored in a file synthesis data DB 105, based at least in part on the analysis result obtained in operation 44 (illustrated in FIG. 4) for email analysis in operation 63.

The background sound selected in operation 63 as described above is combined with the voice data converted in operation 61 at operation 64, and is encoded according to an audio format (for example, MP3, AAC, OGG, wave, etc.) selected by the user. However, if any one operation from among operations 61 through 63 is omitted, operation 64 does not need to be performed. In another embodiment of the present general inventive concept, the order of operations 60 and 61 and operations 62 and 63 may be arranged in any suitable order.

FIG. 7 is a flowchart illustrating an operation for synthesizing a video file illustrated in FIG. 4 according to an embodiment of the present general inventive concept.

It is determined in operation 70 whether or not a user requests an email body to be included in a video file (or a multimedia email). For example, users are apt to read the content of the body while only listening to the voice of the email. If there is a request to include the body, a video file synthesis module 113 (illustrated in FIG. 1) obtains a document for displaying the body from an email pre-processing module 102 in operation 72.

It is determined in operation 72 whether or not the user requests sender information to be inserted into a video file (or a multimedia email). If there is a request to insert the sender information, the sender information is obtained. That is, a sender information extraction unit 111 (illustrated in FIG. 1) receives a sender ID from the email pre-processing module 102, and extracts sender information corresponding to this ID as a medium, from the sender information DB 110.

It is determined in operation 74 whether or not the user requests a background image to be inserted into the video file (or multimedia file).

If the user requests a background image to be inserted, a background image to be inserted is selected in operation 75. A background image selection module 112 (illustrated in FIG. 1) selects a background image from one or more images (for example, still image data, moving picture data) stored in a file synthesis DB 105 based at least in part on the analysis result obtained from operation 44 (illustrated in FIG. 4) for email analysis, in operation 75.

In operation 76, when a combination of two or more of the email body, sender information, or the background image are generated, these are combined, thereby generating one file. When one of the email body, sender information, and the background image is generated, operation 76 is not performed.

The file generated in operation 71, 73, 75, or 76 is encoded according to a video format (for example, MPEG, flash) selected by the user in operation 77.

The present general inventive concept can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves or signal (e.g., wired or wireless data transmission through the Internet). The computer readable recording medium can also be distributed over network coupled computer systems so that the computer readable code is stored and executed in a distributed fashion. Also, functional programs, codes, and code segments to accomplish the present general inventive concept can be easily construed by programmers skilled in the art to which the present general inventive concept pertains.

While the present general inventive concept has been particularly illustrated and described with reference to exemplary embodiments thereof, it will be understood by those of ordinary skill in the art that various changes in form and details may be made therein without departing from the spirit and scope of the present general inventive concept as defined by the following claims. The preferred embodiments should be considered in descriptive sense only and not for purposes of limitation. Therefore, the scope of the general inventive concept is defined not by the detailed description of the invention but by the appended claims and their equivalents, and all differences within the scope will be construed as being included in the present general inventive concept.

What is claimed is:

1. An apparatus to synthesize a multimedia email, the apparatus comprising:
an email analysis unit to analyze the content of an email;
an audio file synthesis unit to synthesize an audio file by using at least part of the analysis result by the email analysis unit;
a video file synthesis unit to synthesize a video file by using at least part of the analysis result by the email analysis unit; and
an audio/video file combining module to combine the audio file and video file.

2. The apparatus of claim 1, wherein the email analysis unit comprises:
a keyword extraction module to extract one or more keywords included in the email; and
an email content analysis module to analyze the content of the email by using the one or more keywords.

3. The apparatus of claim 1, further comprising:
a file synthesis database (DB) to store audio data to be inserted into an audio file and video data to be inserted into a video file.

4. The apparatus of claim 1, further comprising:
an email pre-processing module which comprises:
a tag analyzer to analyze one or more tags of the email;
a token extractor to extract one or more tokens corresponding to the tags; and
a sentence extractor and/or converter to extract, convert, or extract and convert data to be used to generate an audio file or video file from the one or more tokens.

5. The apparatus of claim 1, wherein the audio file comprises voice data, music data, sound effects data, or background sound data, or any combination thereof.

6. The apparatus of claim 1, wherein the video file comprises sender information, an email body, or a background image, or any combination thereof.

7. The apparatus of claim 6, wherein the background image is a still image or a moving picture.

8. The apparatus of claim 1, wherein the audio file synthesis unit comprises a text-to-speech converter, or a background sound selection module, or any combination thereof.

9. The apparatus of claim 8, wherein the background sound selection module is configured to select a background sound based at least in part on an analysis result generated by the email analysis unit.

10. The apparatus of claim 1, wherein the video file synthesis unit comprises a sender information extraction unit for obtaining additional information on a sender.

11. The apparatus of claim 1, wherein the video synthesis unit comprises a background image selection module to select a background image to be inserted into a video file.

12. The apparatus of claim 11, wherein the background image selection module selects a background image by using an analysis result by the email analysis unit.

13. A method of synthesizing a multimedia email, the method comprising:
analyzing the content of an email;
synthesizing an audio file by using at least in part the analysis result of the content of the email;
synthesizing a video file by using at least in part the analysis result of the content of the email; and
combining the synthesized audio file and video file.

14. The method of claim 13, further comprising email pre-processing which comprises:
classifying one or more items of the email by using tags;
extracting one or more tokens corresponding to the classified items; and
extracting, converting, or extracting and converting data to be used for synthesizing a file from at least the one or more tokens.

15. The method of claim 13, wherein the synthesizing of the audio file comprises converting email text into voice data.

16. The method of claim 13, wherein the synthesizing of the audio file comprises selecting a background sound based at least in part on the analysis result of the content of the email.

17. The method of claim 13, wherein the synthesizing of the video file comprises one or more of:
obtaining email body data;
extracting information on the sender of the email; and
selecting a background image based at least in part on the analysis result of the content of the email.

18. The method of claim 17, wherein the synthesizing of the video file further comprises combining two or more of the email body, sender information and a background image.

19. The method of claim 17, wherein the sender information comprises one or more of the name of a sender, occupation, importance, workplace information, a photo of a sender, and memos written by a user in relation to a sender.

20. The method of claim 13, wherein the synthesizing of the multimedia email further comprises encoding the audio file based at least in part on a received selection of an audio format.

21. The method of claim 13, wherein the synthesizing of the video file further comprises encoding the video file based at least in part on a received selection of a video format.

22. The method of claim 13, wherein the combining of the synthesized audio and video files comprises synchronizing voice data included in the audio file with body data included in the videofile.

23. A computer readable medium having embodied thereon a computer program to execute a method of synthesizing a multimedia email, wherein the method comprises:
analyzing the content of an email;
synthesizing an audio file by using at least part of the analysis result of the content of the email;
synthesizing a video file by using at least part of the analysis result of the content of the email; and
combining the synthesized audio file and video file.
